(19) United States
(12) Patent Application Publication
(10) Pub. No.: US 2026/0128329 A1
(43) Pub. Date: May 7, 2026

(54) GASKET FOR REINFORCING SURFACE PRESSURE AND SEPARATOR ASSEMBLY INCLUDING SAME

(71) Applicants: Hyundai Motor Company, Seoul (KR); Kia Corporation, Seoul (KR)

(72) Inventors: Yeong Hoon Jeong, Hwaseong (KR); Seung Hun Han, Hwaseong (KR); Duk Hoon Kwon, Hwaseong (KR)

(21) Appl. No.: 19/039,188

(22) Filed: Jan. 28, 2025

(30) Foreign Application Priority Data
Nov. 5, 2024 (KR) 10-2024-0154921

(51) Int. Cl. H01M 8/0276; H01M 8/0247; H01M 8/0267; H01M 8/04007; H01M 8/2483

(52) U.S. Cl. CPC H01M 8/0276; H01M 8/0247; H01M 8/0267; H01M 8/04007; H01M 8/2483

(57) ABSTRACT

A gasket for reinforcing surface pressure on a separator assembly includes bridges aligned with piercing holes along sealing regions. Its double-uneven structure is designed to accommodate thickness or shape variations, offsetting shrinkage and improving sealing force. By placing bridges within troughs formed by protrusions, the gasket ensures consistent sealing around both reaction and cooling surfaces. Different bridging dimensions are provided for distinct manifold configurations or injection molding gate positions, allowing optimized reinforcement of seal lines, even at partial manifolds or around piercing holes. Ultimately, this design enhances reliability and uniform surface pressure distribution, reducing the risk of leakage.

### CROSS-REFERENCE TO RELATED APPLICATION

This application claims, under 35 U.S.C. § 119(a), the benefit of Korean Patent Application No. 10-2024-0154921, filed on Nov. 5, 2024, the entire contents of which are incorporated herein by reference.

### TECHNICAL FIELD

The present disclosure relates to a gasket capable of reinforcing surface pressure through a bridge provided in a portion where surface pressure is weak, and a separator assembly including the same.

### BACKGROUND

A fuel cell is a type of power generation device configured to convert chemical energy of fuel into electrical energy by electrochemical reaction within a stack. It may be used to supply power for industrial, household, and vehicle driving, as well as to power small electronic products such as portable devices. Recently, fuel cells have been gaining broader adoption as a high-efficiency, clean energy source.

Each of unit cells that constitute a typical fuel cell stack has a membrane-electrode assembly (MEA) located at the innermost position. The membrane-electrode assembly is composed of a polymer electrolyte membrane able to transport protons, and catalyst layers applied onto respective sides of the electrolyte membrane so that hydrogen and oxygen may react, namely an anode and a cathode.

A pair of gas diffusion layers (GDL) is stacked on both outer surfaces of the membrane-electrode assembly, and a separator assembly with a flow field formed to supply fuel and discharge water generated by reaction is disposed on the outer surfaces of the gas diffusion layers with a gasket therebetween. The separator assembly is formed by joining an anode separator disposed on the anode and a cathode separator disposed on the cathode to face each other. The anode separator and the cathode separator are joined and integrated, whereby manifolds communicate with each other and are configured with similar shapes so that the reaction surfaces are disposed at the same position. Also, an end plate is attached to each of the two outermost surfaces of the stacked unit cells to support and secure the components.

Gaskets are disposed on the reaction surface and cooling surface of the cathode separator. Each gasket is formed by an injection molding process, and in the cathode separator, a double-sided injection molding process is performed such that gaskets on the reaction surface and the cooling surface are injection molded simultaneously. Piercing holes are formed along lines in which the gaskets are disposed for the double-sided injection molding process. Double-sided injection molding of the cathode separator is implemented by transferring the material provided on one surface of the cathode separator to the other surface of the cathode separator through the piercing holes.

However, due to the presence of the piercing holes, a shrinkage difference arises between the gasket placed on these holes and the gaskets elsewhere. Additionally, variations in injection volume after gasket injection molding causes the gasket over the piercing holes to be lower than in height than gaskets in other areas. As a result, the surface pressure at the piercing holes decreases, weakening overall sealing performance.

### SUMMARY OF THE DISCLOSURE

An object of the present disclosure is to provide a gasket capable of reinforcing surface pressure between a gasket and a separator through a bridge provided in a portion where the surface pressure is weak, and a separator assembly including the same.

Another object of the present disclosure is to provide a gasket capable of reinforcing surface pressure between a gasket and a separator by providing a relatively large bridge in a portion where the surface pressure is relatively weak in order to eliminate the surface pressure imbalance between the separator and the gasket.

An embodiment of the present disclosure provides a gasket for reinforcing surface pressure. In the gasket disposed on a separator including at least one piercing hole provided along a line where sealing is required, the gasket includes a double uneven structure protruding from the separator and a bridge provided at a position corresponding to the at least one piercing hole, and the bridge is disposed in a trough provided by the double uneven structure.

In some embodiments, a height of a top of the bridge may be less than a height of a top of the double uneven structure based on one surface of the separator.

In some embodiments, the gasket may include an upper gasket disposed on a reaction surface of the separator and a lower gasket disposed on a cooling surface of the separator, and the bridge may include an upper bridge provided to the upper gasket and a lower bridge provided to the lower gasket based on a position of the piercing hole.

In some embodiments, the upper bridge may be thicker than the lower bridge based on a direction in which the gasket extends, or a height of a top of the upper bridge based on the reaction surface of the separator may be greater than a height of a top of the lower bridge based on the cooling surface of the separator.

In some embodiments, the gasket may include a first gasket disposed between a perimeter of the separator and manifolds through which reaction gases or coolant flow, and a second gasket disposed on a flow path of the reaction gases or coolant discharged from the manifolds or introduced into the manifolds.

In some embodiments, the bridge may include a first bridge provided to the first gasket and a second bridge provided to the second gasket.

In some embodiments, among a plurality of second bridges provided on the second gasket disposed at a position corresponding to any one of the manifolds, the second bridges disposed at both ends may be larger in size than the remaining second bridges.

In some embodiments, the second gasket may include a plurality of extensions extending along the flow path of the reaction gases or coolant discharged from the manifolds or introduced into the manifolds, and the second bridges may be disposed outside connection points between the second gasket and the two extensions disposed at both ends based on any one of the manifolds.

In some embodiments, among a plurality of second bridges provided on the second gasket disposed at a position corresponding to each of coolant manifolds associated with the coolant among the manifolds, at least one second bridge disposed at a central portion of the second gasket may be smaller in size than the remaining second bridges.

In some embodiments, the bridge may include a third bridge provided at a point of the first gasket connected to the second gasket disposed on the cooling surface of the separator, and the third bridge may be larger in size than the first bridge.

Another embodiment of the present disclosure provides a separator assembly having a gasket for reinforcing surface pressure. The separator assembly includes a cathode separator including a plurality of piercing holes provided along a line where sealing is required and a gasket including a plurality of bridges provided at positions corresponding to the piercing holes, in which each of the bridges is disposed on a double uneven structure of the gasket protruding from the cathode separator.

In some embodiments, each of the bridges may be disposed in a trough provided by the double uneven structure.

In some embodiments, the piercing holes may include a first piercing hole disposed between the perimeter of the cathode separator and manifolds through which reaction gases or coolant flow, and a second piercing hole disposed in a direction toward a central area of the cathode separator from the manifolds, and the bridges may include a first bridge provided at a position corresponding to the first piercing hole and a second bridge disposed at a position corresponding to the second piercing hole.

In some embodiments, among a plurality of second bridges, the second bridges disposed on the second piercing holes disposed at both ends among a plurality of second piercing holes corresponding to each of the manifolds may be larger in size than the remaining second bridges.

In some embodiments, a third piercing hole may be provided in a direction toward the central area of the cathode separator from some manifolds associated to the reaction gases among the manifolds, the third piercing hole may be spaced apart from some manifolds compared to the second piercing hole, and among a plurality of second bridges, the second bridges disposed on the third piercing holes disposed at both ends among a plurality of third piercing holes corresponding to each of some manifolds may be larger in size than the remaining second bridges.

In some embodiments, a plurality of first piercing holes may include a fourth piercing hole disposed on an extension line in a direction in which the third piercing holes are arranged, the plurality of the bridges may include a third bridge provided at a position corresponding to the fourth piercing hole, and the third bridge may be larger in size than the first bridge.

In some embodiments, the gasket may include an upper gasket disposed on a reaction surface of the cathode separator and a lower gasket disposed on a cooling surface of the cathode separator, and an upper bridge disposed on the upper gasket among the bridges may be larger in size than a lower bridge disposed on the lower gasket among the bridges.

In some embodiments, a separator assembly for reinforcing surface pressure at a piercing hole may comprise a separator having at least one piercing hole disposed along a sealing region and a gasket disposed on the separator, the gasket including at least one bridge aligned with the at least one piercing hole, the bridge may be configured with a thickness or shape selected to compensate for shrinkage differences or to increase sealing force relative to surrounding portions of the gasket.

In some embodiments, the gasket may be formed by an injection molding process having one or more gate locations, and the bridge may have a dimension larger or smaller than other bridges of the gasket based on proximity to a gate location to offset thickness variations that occur during injection molding.

In some embodiments, the gasket may comprise a double-uneven structure protruding from the separator, and each bridge may be at least partially disposed within a trough defined by the double-uneven structure.

As discussed, the method and system suitably include use of a controller or processer.

In other embodiments, vehicles are provided that comprise an apparatus as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a cathode separator according to an embodiment of the present disclosure;

FIG. 2 shows an upper gasket according to an embodiment of the present disclosure;

FIG. 3 shows a lower gasket according to an embodiment of the present disclosure;

FIG. 4 shows a bridge disposed on the gasket according to an embodiment of the present disclosure;

FIG. 5 is a cross-sectional view along line A-A′ of FIG. 4;

FIG. 6 is a cross-sectional view along line B-B′ of FIG. 4;

FIG. 7 shows a plurality of bridges disposed on the upper gasket according to an embodiment of the present disclosure;

FIG. 8 shows a plurality of bridges disposed on the lower gasket according to an embodiment of the present disclosure;

FIG. 9 shows a fourth piercing hole according to an embodiment of the present disclosure;

FIG. 10 shows a third bridge located corresponding to the fourth piercing hole of FIG. 9; and

FIG. 11 shows a difference between the upper gasket and the lower gasket on the cathode separator according to an embodiment of the present disclosure.

### DETAILED DESCRIPTION

The advantages and features of the present disclosure and the methods of achieving the same will become apparent with reference to embodiments described in detail below together with the accompanying drawings. However, the present disclosure is not limited to the embodiments disclosed below but may be implemented in various different forms. These embodiments are provided only to make the present disclosure complete and to fully inform those skilled in the art of the scope of the present disclosure, and the present disclosure is merely defined by the scope of the claims. Throughout the specification, the same reference numerals designate the same components.

In addition, the reason why the names of the components herein are divided into first, second, etc. is to distinguish them when the names of the components are the same, and the order in the description below is not necessarily limited to that order.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “piercing hole” herein refers to any opening or through-hole formed in a separator (e.g., via drilling, punching, or molding) that permits transfer of a gasket-forming material from one surface of the separator to the other surface during a molding process, or that otherwise aligns with a sealing region to accommodate fluid or material flow.

The term “double uneven structure” herein refers to a cross-sectional shape in a gasket having two protruding ribs (or “humps”) defining a trough therebetween. In some embodiments, these two protrusions and the trough together constitute the primary sealing profile of the gasket.

The term “bridge” herein refers to a locally thickened or modified portion of the gasket, arranged to compensate for potential shrinkage or sealing force loss that might otherwise occur at or near a piercing hole or other critical area of the separator. In some embodiments, the bridge is disposed within the trough of a double uneven structure.

The term “gate” herein refers to an injection point or passage in a mold through which the gasket-forming material (e.g., elastomer, rubber, etc.) is introduced during the injection molding process.

The term “separator” herein refers to any plate or panel in a fuel cell assembly or similar device, on which a gasket is disposed for sealing. While in some embodiments the separator is specifically a cathode separator, in other embodiments it may be an anode separator, a bipolar plate, or another partitioning element in a fluid system.

The term “manifold” herein refers to an inlet or outlet opening formed in or through the separator for delivering and/or removing reactants (e.g., hydrogen, oxygen) or coolant fluids within a fuel cell stack or other fluid-processing assembly.

The detailed description is intended to illustrate the present disclosure. It should also be understood that the foregoing description is intended to illustrate preferred embodiments of the present disclosure and that the present disclosure may be used in a variety of other combinations, modifications, and environments. Specifically, changes or modifications are possible within the scope of the concept of the disclosure herein, the scope equivalent to the described disclosure, and/or the scope of technology or knowledge in the art. These embodiments are used to describe the best state for implementing the technical idea of the present disclosure, and various modifications required for specific application fields and uses of the present disclosure are also possible. Therefore, the detailed description is not intended to limit the present disclosure to the disclosed embodiments. Moreover, the appended claims should be construed to include other embodiments.

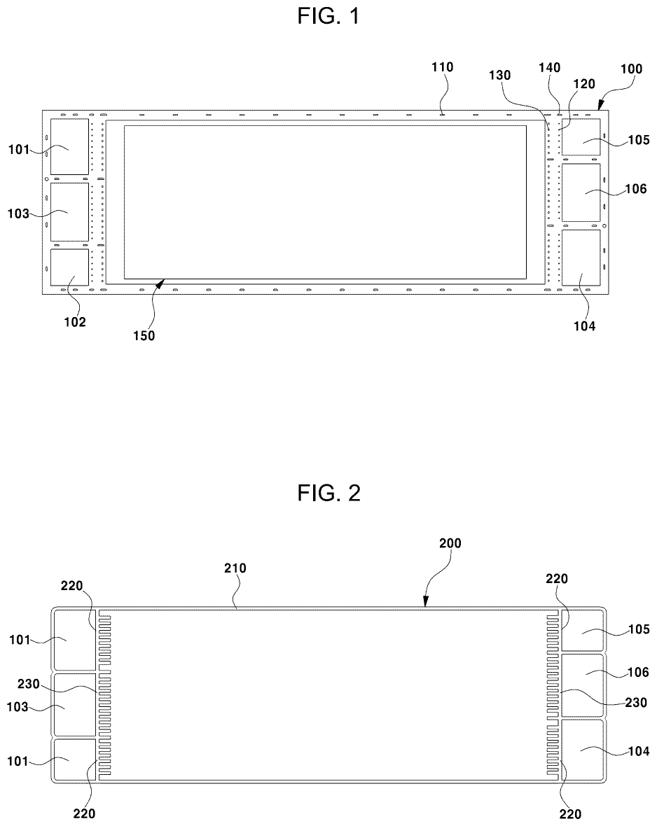

FIG. 1 shows a cathode separator according to an embodiment of the present disclosure.

Referring to FIG. 1, a cathode separator 100 constituting a fuel cell stack may include multiple piercing holes 110, 120, 130, 140. The piercing holes 110, 120, 130, 140 may be provided along a sealing line of the cathode separator 100 to perform simultaneous injection molding of gaskets disposed on the reaction surface and cooling surface of the cathode separator 100. During injection molding, gasket injection molding may be performed on one surface of the cathode separator 100, and a material for gasket injection molding may be transferred onto the other surface of the cathode separator 100 through the piercing holes 110, 120, 130, 140. Accordingly, simultaneous injection molding of gaskets onto the reaction surface and cooling surface of the cathode separator 100 may be implemented. The piercing holes 110, 120, 130, 140 may be formed for double-sided injection molding of gaskets on the cathode separator 100.

The cathode separator 100 may include manifolds 101, 102, 103, 104, 105, 106 through which reaction gases or coolant flow. The manifolds 101, 102, 103, 104, 105, 106 may include inlet manifolds 101, 105 through which reaction gases are introduced, outlet manifolds 102, 104 through which reaction gases are discharged, and coolant manifolds 103, 106 through which coolant is introduced or discharged. The inlet manifolds 101, 105 may include a first inlet manifold 101 into which hydrogen is introduced and a second inlet manifold 105 into which oxygen is introduced. The outlet manifolds 102, 104 may include a first outlet manifold 104 from which hydrogen is discharged, and a second outlet manifold 102 from which oxygen is discharged.

The cathode separator 100 may include a central area 150. The central area 150 may be an area overlapping the reaction area of the cathode separator 100.

The piercing holes 110, 120, 130, 140 may include a first piercing hole 110, a second piercing hole 120, a third piercing hole 130, and a fourth piercing hole 140.

The first piercing hole 110 may be disposed between the perimeter of the cathode separator 100 and the manifolds 101, 102, 103, 104, 105, 106 through which reaction gases or coolant flow. A plurality of first piercing holes 110 may be provided.

The second piercing hole 120 may be disposed in a direction toward the central area 150 of the cathode separator 100 from the manifolds 101, 102, 103, 104, 105, 106. Specifically, second piercing holes 120 may be provided on the flow path of the reaction gases or coolant discharged from the manifolds 101, 102, 103, 104, 105, 106 or introduced into the manifolds 101, 102, 103, 104, 105, 106. Accordingly, the second piercing holes 120 may be provided in the space between the manifolds 101, 102, 103, 104, 105, 106 and the central area 150.

The third piercing hole 130 may be disposed in a direction toward the central area 150 of the cathode separator 100 from some manifolds 101, 102, 104, 105 associated with the reaction gases among the manifolds 101, 102, 103, 104, 105, 106. Specifically, third piercing holes 130 may be provided on the flow path of the reaction gases discharged from some manifolds 101, 102, 104, 105 or introduced into some manifolds 101, 102, 104, 105. The third piercing holes 130 may be provided in the space between some manifolds 101, 102, 104, 105 and the central area 150, and may be spaced apart from some manifolds 101, 102, 104, 105 compared to the second piercing holes 120. Briefly, the third piercing holes 130 may be located adjacent to the central area 150 compared to the second piercing holes 120. The second piercing holes 120 and the third piercing holes 130 may be disposed in two rows between some manifolds 101, 102, 104, 105 and the reaction area 150. The second piercing holes 120 and the third piercing holes 130 may be disposed in respective rows.

The first piercing holes 110 may include a fourth piercing hole 140 disposed on an extension line in the direction in which the third piercing holes 130 are arranged. The hole disposed on the extension line in the direction in which the third piercing holes 130 are arranged among the piercing holes 110 disposed along the perimeter line of the cathode separator 100 may be the fourth piercing hole 140. For example, four fourth piercing holes 140 may be formed in the cathode separator 100. The fourth piercing hole 140 may be provided at a point where a virtual line on which the first piercing holes 110 are arranged and a virtual line on which the third piercing holes 130 are arranged meet each other. In addition, the first piercing holes 110 disposed substantially parallel to the flow path of the reaction gases or coolant within the reaction area of the cathode separator 100 may be disposed in a single row on each of the top and bottom of the central area 150 of the cathode separator 100, and the fourth piercing hole 140 may be disposed at a position where the first piercing holes 110 disposed in a single line are bent. For example, in the cathode separator 100, the manifolds 101, 102, 103, 104, 105, 106 may be disposed on the left and right of the central area 150, and the first piercing holes 110 may be disposed along the sealing lines of the upper portion and lower portion of the gaskets of the central area 150.

For example, the first piercing hole 110 may be larger than the second piercing hole 120 and the third piercing hole 130. The fourth piercing hole 140 may be larger than the first piercing hole 110.

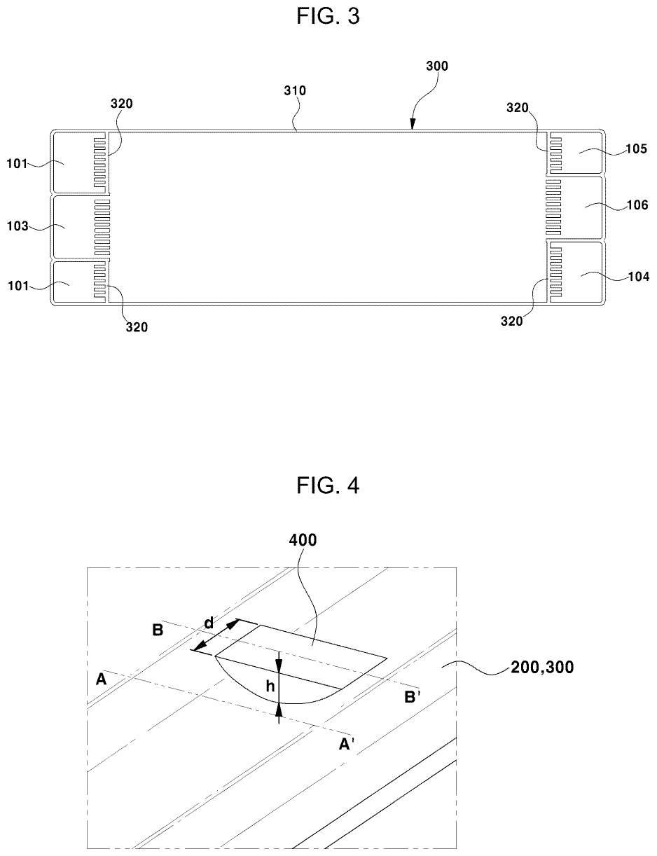

FIG. 2 shows an upper gasket according to an embodiment of the present disclosure, and FIG. 3 shows a lower gasket according to an embodiment of the present disclosure.

Referring to FIGS. 1 to 3, gaskets 200, 300 may be disposed on the cathode separator 100. The gaskets 200, 300 may include an upper gasket 200 located on the reaction surface of the cathode separator 100 and a lower gasket 300 located on the cooling surface of the cathode separator 100.

The upper gasket 200 may include a first upper gasket 210 disposed between the perimeter of the cathode separator 100 and the manifolds 101, 102, 103, 104, 105, 106 through which reaction gases or coolant flow, and second upper gaskets 220, 230 disposed on the flow path of the reaction gases or coolant discharged from the manifolds 101, 102, 103, 104, 105, 106 or introduced into the manifolds 101, 102, 103, 104, 105, 106. The first upper gasket 210 may be disposed on the sealing line of the perimeter of the central area 150 of the cathode separator 100 and on the sealing line surrounding the manifolds 101, 102, 103, 104, 105, 106. The second upper gaskets 220, 230 may be disposed in the space between the manifolds 101, 102, 103, 104, 105, 106 and the central area 150 of the cathode separator 100. The first upper gasket 210 and the second upper gaskets 220, 230 may be connected to each other. The second upper gaskets 220, 230 may include a second-1 upper gasket 220 disposed in the space between some manifolds 101, 102, 104, 105 through which reaction gases flow among the manifolds 101, 102, 103, 104, 105, 106 and the central area 150 of the cathode separator 100, and a second-2 upper gasket 230 disposed in the space between the coolant manifolds 103, 106 through which coolant flows among the manifolds 101, 102, 103, 104, 105, 106 and the central area 150 of the cathode separator 100.

The first upper gasket 210 may be disposed on the first piercing holes 110 and the fourth piercing holes 140 formed in the sealing line of the cathode separator 100. The second-1 upper gasket 220 and the second-2 upper gasket 230 may be disposed on the second piercing holes 120.

The lower gasket 300 may include a first lower gasket 310 disposed between the perimeter of the cathode separator 100 and the manifolds 101, 102, 103, 104, 105, 106 through which reaction gases or coolant flow, and a second lower gasket 320 disposed on the flow path of the reaction gases or coolant discharged from the manifolds 101, 102, 103, 104, 105, 106 or introduced into the manifolds 101, 102, 103, 104, 105, 106. The first lower gasket 310 may be disposed on the sealing line of the perimeter of the central area 150 of the cathode separator 100 and on the sealing line surrounding the manifolds 101, 102, 103, 104, 105, 106. The second lower gasket 320 may be disposed in the space between some manifolds 101, 102, 104, 105 among the manifolds 101, 102, 103, 104, 105, 106 and the central area 150 of the cathode separator 100. The second lower gasket 320 may not be disposed in the space between the coolant manifolds 103, 106 and the central area 150 of the cathode separator 100. The first lower gasket 310 and the second lower gasket 320 may be connected to each other.

The first lower gasket 310 may be disposed on the first piercing holes 110 and the fourth piercing holes 140 formed along the sealing line of the cathode separator 100. The second lower gasket 320 may be disposed on the third piercing holes 130.

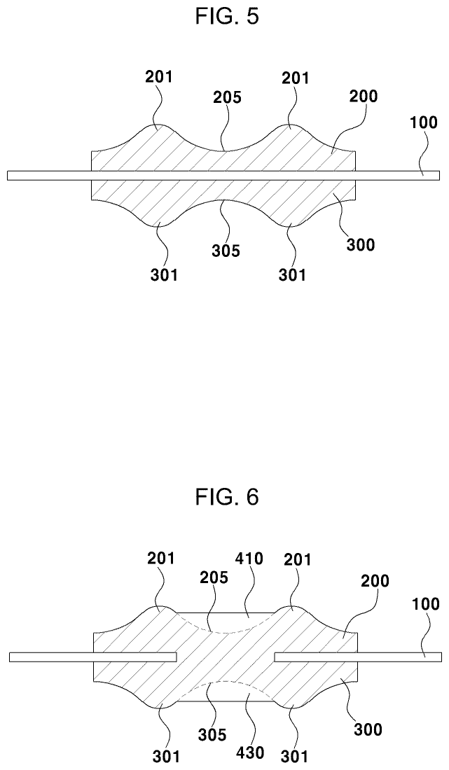

FIG. 4 shows a bridge disposed on the gasket according to an embodiment of the present disclosure, FIG. 5 is a cross-sectional view along line A-A′ of FIG. 4, and FIG. 6 is a cross-sectional view along line B-B′ of FIG. 4.

Referring to FIGS. 1 and 4 to 6, the gaskets 200, 300 may include a bridge 400 provided at a position corresponding to at least one of the piercing holes 110, 120, 130, 140 provided in the cathode separator 100. The bridge 400 may be formed together with the gaskets 200, 300 during the injection molding process. The gaskets 200, 300 are disposed along the sealing line on the cathode separator 100, and may be formed of double uneven structures 201, 301. The cross-section of the gaskets 200, 300 cut in a direction perpendicular to the direction in which the gaskets 200, 300 extend may have two protruding structures and troughs 205, 305 between the two protruding structures. Specifically, a bridge 400 may be disposed on the double uneven structure 201 of the upper gasket 200 disposed on the reaction surface of the cathode separator 100, and a bridge 400 may be disposed on the double uneven structure 301 of the lower gasket 300 disposed on the cooling surface of the cathode separator 100. The bridge 400 may have a thickness d in the direction in which the gaskets 200, 300 extend, and may have a height h between the upper surfaces of the double uneven structures 201, 301 of the gaskets 200, 300 and the top of the bridge 400. For example, based on one surface of the cathode separator 100, the height of the top of the bridge 400 may be less than the height of the top of the double uneven structures 201, 301. The bridge 400 may be disposed on each of the troughs 205, 305 provided by the double uneven structures 201, 301.

The bridge 400 may be provided at positions corresponding to all or part of the piercing holes 110, 120, 130, 140. By inserting the bridge 400 into the troughs 205, 305 provided by the double uneven structures 201, 301, a decrease in surface pressure between the cathode separator 100 and the gaskets 200, 300, which may occur due to the piercing holes 110, 120, 130, 140, may be prevented.

Specifically, the bridge 400 may include an upper bridge 410 located in the double uneven structure 201 of the upper gasket 200 provided on the reaction surface of the cathode separator 100 and a lower bridge 430 located in the double uneven structure 301 of the lower gasket 300 provided on the cooling surface of the cathode separator 100. The upper bridge 410 may be provided in the upper trough 205, which is a space defined by the double uneven structure 201. The lower bridge 430 may be provided in the lower trough 305, which is a space defined by the double uneven structure 301.

The bridge 400 located adjacent to a gate applied to a mold during injection molding of the gaskets 200, 300 may be larger in size than other bridges 400. The gate applied to the mold may be a passage through which a material for injection molding is transferred. A plurality of gates may be provided within the mold, and the thickness of the gaskets 200, 300 formed between adjacent gates may be greater than the thickness of the gaskets 200, 300 at positions adjacent to the gates. In order to eliminate the imbalance in surface pressure caused by different thicknesses of gaskets 200, 300, a relatively large bridge 400 may be provided near the gate at positions where relatively thin gaskets 200, 300 are provided. That is, the bridge 400 may have a dimension larger or smaller than other bridges 400 of the gasket based on proximity to a gate location to offset thickness variations that occur during injection molding. A large bridge 400 may mean that the thickness d in the extension direction of the gaskets 200, 300 is high or that the height h on the gaskets 200, 300 is great. Although the height h of each of a plurality of bridges 400 may be the same during stacking of unit cells of the fuel cell, the heights h of the bridges 400 before stacking of the unit cells may be different from each other.

The size of the bridge 400 may be proportional to the size of the piercing holes 110, 120, 130, 140 formed at corresponding positions. The bridge 400 is configured to prevent surface pressure imbalance caused by the piercing holes 110, 120, 130, 140, and after stacking of unit cells of the fuel cell, it may be ideal for the thickness d of the bridge 400 to match the width of the piercing holes 110, 120, 130, 140. For example, the size of the bridge 400 located on the second piercing hole 120 or the third piercing hole 130 may be less than the size of the bridge 400 located on the first piercing hole 110 or the fourth piercing hole 140.

According to an embodiment of the present disclosure, although a height difference of the gaskets 200, 300 may occur due to a shrinkage difference between the piercing holes 110, 120, 130, 140 and other portions of the cathode separator 100 after injection molding of the gaskets 200, 300, the shrinkage difference at positions where the piercing holes 110, 120, 130, 140 are provided may be prevented by the bridges 400 disposed at positions corresponding to the piercing holes 110, 120, 130, 140. By preventing the shrinkage difference, the problem of the height of the gaskets 200, 300 at positions where the piercing holes 110, 120, 130, 140 are provided being less than the height of the gaskets 200, 300 at the other positions may be solved.

According to an embodiment of the present disclosure, bridges 400 are located on the piercing holes 110, 120, 130, 140, so that the surface pressure between the piercing holes 110, 120, 130, 140 and the gaskets 200, 300 may be reinforced.

According to an embodiment of the present disclosure, since bridges 400 are disposed on gaskets 200, 300 having double uneven structures 201, 301, sealing performance may be improved through the gaskets 200, 300.

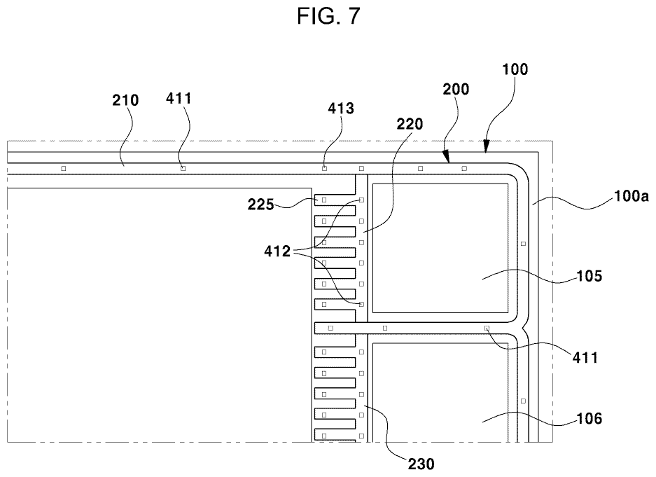

FIG. 7 shows a plurality of bridges disposed on the upper gasket according to an embodiment of the present disclosure.

Referring to FIGS. 1 and 7, the upper gasket 200 may be disposed on the reaction surface of the cathode separator 100. The upper gasket 200 may include a first upper gasket 210 disposed between the perimeter line of the cathode separator 100 and the manifolds 101, 102, 103, 104, 105, 106, a second-1 upper gasket 220 disposed between some manifolds 101, 102, 104, 105 through which reaction gases flow among the manifolds 101, 102, 103, 104, 105, 106 and the central area 150 of the cathode separator 100, and a second-2 upper gasket 230 disposed between the coolant manifolds 103, 106 through which coolant flows among the manifolds 101, 102, 103, 104, 105, 106 and the central area 150 of the cathode separator 100. The second-1 upper gasket 220 may include a plurality of extensions 225 extending along the flow path of the reaction gases or coolant discharged from some manifolds 101, 102, 104, 105 or introduced into some manifolds 101, 102, 104, 105.

The upper bridges 411, 412, 413 disposed on the upper gasket 200 may include first upper bridges 411 spaced apart from each other on the first upper gasket 210, second upper bridges 412 disposed on the second upper gaskets 220, 230, and third upper bridges 413 disposed on the fourth piercing holes 140. The first upper bridge 411 may be larger in size than the second upper bridge 412, and the third upper bridge 413 may be larger in size than the first upper bridge 411.

Among the second upper bridges 412 on the second upper gaskets 220, 230 located corresponding to each of the manifolds 101, 102, 103, 104, 105, 106, the second upper bridges 412 disposed at both ends may be larger in size than the remaining second upper bridges 412. Specifically, among the second upper bridges 412, the second upper bridges 412 disposed on the second piercing holes 120 disposed at both ends among the second piercing holes 120 corresponding to each of the manifolds 101, 102, 103, 104, 105, 106 may be larger in size than the remaining second upper bridges 212. Specifically, two second upper bridges 412 may be disposed on the second upper gaskets 220, 230 corresponding to each of six manifolds 101, 102, 103, 104, 105, 106. Accordingly, twelve second upper bridges 412 may be disposed on the reaction surface of the cathode separator 100. Due to the presence of the extensions 225, the surface pressure between the second upper gaskets 220, 230 and the cathode separator 100 may not be evenly distributed. In particular, both ends of the second upper gaskets 220, 230 corresponding to each of the manifolds 101, 102, 103, 104, 105, 106 may be vulnerable to surface pressure. Accordingly, among the second upper bridges 412 disposed on the second upper gaskets 220, 230, the size of the second upper bridges 412 disposed at both ends is made relatively large so that the portion where the surface pressure is weak may be reinforced. The second upper bridges 412 may be disposed outside the connection points between the second upper gaskets 220, 230 and the two extensions 225 disposed at both ends based on any one of the manifolds 101, 102, 103, 104, 105, 106. The second upper bridge 412 having a relatively large size may be disposed offset from the extension line in the direction in which the extensions 225 extend. However, the second upper bridge 412 having a relatively large size may be disposed so as to coincide with the direction in which the extensions 225 extend.

Among the second upper bridges 412 disposed on the second-2 upper gasket 230 disposed at a position corresponding to each of the coolant manifolds 103, 106 associated with the coolant among the manifolds 101, 102, 103, 104, 105, 106, at least one second upper bridge 412 disposed in the central portion of the second-2 upper gasket 230 may be smaller in size than the remaining second upper bridges 412. The material flowing through the mold gate meets the central portion of the second-2 upper gasket 230 for sealing of the coolant manifolds 103, 106. Therefore, the thickness of the central portion of the second-2 upper gasket 230 may be greater than the thickness of other portions of the second-2 upper gasket 230. Accordingly, in order to ensure uniformity of surface pressure, the second upper bridges 412 disposed in the central portion of the second-2 upper gasket 230 may be smaller in size than the other second upper bridges 412.

The third upper bridge 413 may be disposed on the fourth piercing hole 140 that is disposed on an extension line in the direction in which the third piercing holes 130 are arranged among the first upper bridges 411. The third upper bridge 413 may be disposed on the extension line in the direction in which the extensions 225 are arranged while being disposed on the first upper gasket 210.

According to an embodiment of the present disclosure, by providing a relatively large bridge in a portion where surface pressure is weak during an injection molding process, the surface pressure imbalance between the gaskets 200, 300 and the cathode separator 100 may be eliminated.

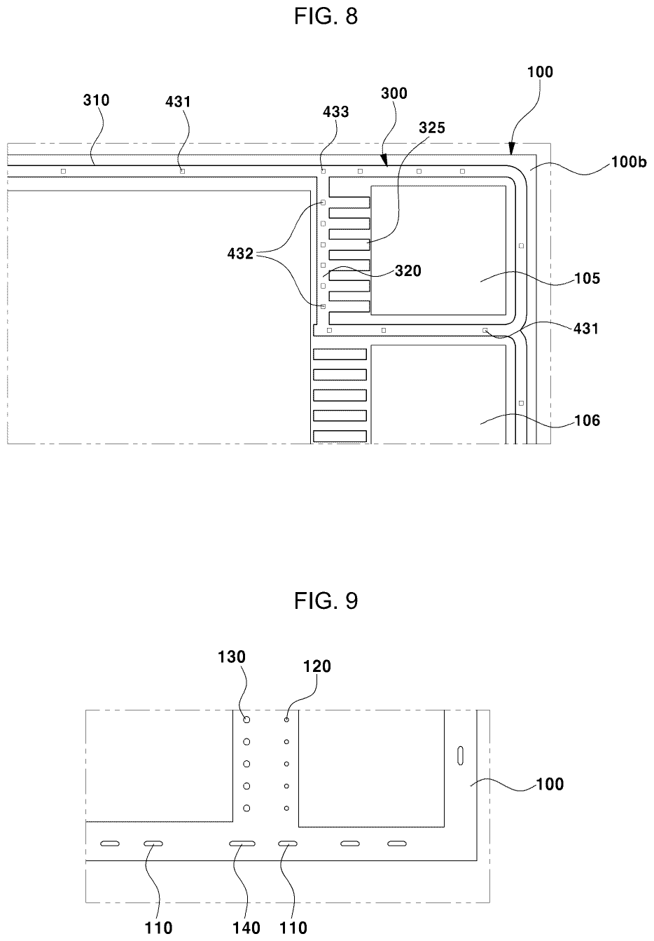

FIG. 8 shows a plurality of bridges disposed on the lower gasket according to an embodiment of the present disclosure.

Referring to FIGS. 1 and 8, the lower gasket 300 may be disposed on the cooling surface of the cathode separator 100. The lower gasket 300 may include a first lower gasket 310 disposed between the perimeter line of the cathode separator 100 and the manifolds 101, 102, 103, 104, 105, 106, and a second lower gasket 320 disposed between some manifolds 101, 102, 104, 105 through which reaction gases flow among the manifolds 101, 102, 103, 104, 105, 106 and the central area 150 of the cathode separator 100. The second lower gasket 320 may include a plurality of extensions 325 extending along the flow path of the reaction gases discharged from some manifolds 101, 102, 104, 105 or introduced into some manifolds 101, 102, 104, 105.

The lower bridges 431, 432, 433 disposed on the lower gasket 300 may include first lower bridges 431 spaced apart from each other on the first lower gasket 310, second lower bridges 432 disposed on the second lower gasket 320, and third lower bridges 433 disposed on the fourth piercing holes 140. The first lower bridge 431 may be larger in size than the second lower bridge 432, and the third lower bridge 433 may be larger in size than the first lower bridge 431.

Among the second lower bridges 432 on the second lower gasket 320 provided at a position corresponding to each of some manifolds 101, 102, 104, 105 through which reaction gases flow among the manifolds 101, 102, 103, 104, 105, 106, the second lower bridges 432 disposed at both ends may be larger in size than the remaining second lower bridges 432. Among the second lower bridges 432, the second lower bridges 432 provided on the third piercing holes 130 disposed at both ends among the third piercing holes 130 corresponding to each of some manifolds 101, 102, 104, 105 may be larger in size than the remaining second lower bridges 432. Specifically, two second lower bridges 432 may be disposed on the second lower gasket 320 corresponding to each of the four manifolds 101, 102, 104, 105. Accordingly, eight second lower bridges 432 may be disposed on the cooling surface of the cathode separator 100. Due to the presence of the extensions 325, the surface pressure between the second lower gasket 320 and the cathode separator 100 may not be evenly distributed. In particular, both ends of the second lower gasket 320 corresponding to each of some manifolds 101, 102, 104, 105 may be vulnerable to surface pressure. Accordingly, the size of the second lower bridges 432 disposed at both ends among the second lower bridges 432 disposed on the second lower gasket 320 is made relatively larger so that the portion where the surface pressure is weak may be reinforced. The second lower bridges 432 may be disposed outside the connection points between the second lower gasket 320 and the two extensions 325 disposed at both ends based on any one of some manifolds 101, 102, 104, 105. The second lower bridge 432 that is relatively large in size may be disposed offset from the extension line in the direction in which the extensions 325 extend. However, the second lower bridge 432 that is relatively large in size may be disposed so as to coincide with the direction in which the extensions 325 extend.

The third lower bridge 433 may be disposed on the fourth piercing hole 140 that is disposed on an extension line in the direction in which the third piercing holes 130 are arranged among the first lower bridges 431. The third lower bridge 433 may be a bridge closest to the point where the first lower gasket 310 and the second lower gasket 320 meet among the first lower bridges 431.

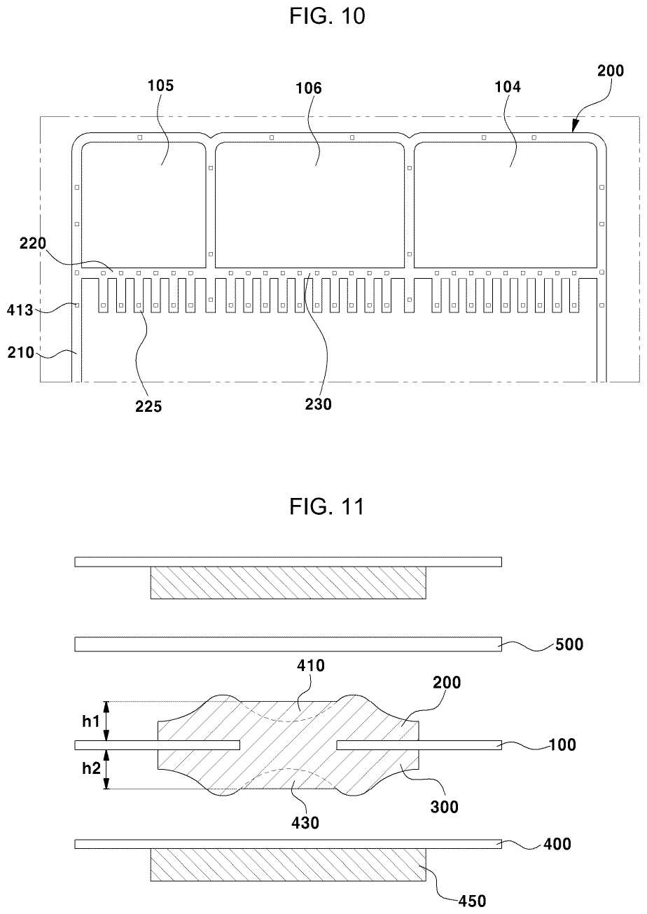

FIG. 9 shows a fourth piercing hole according to an embodiment of the present disclosure, and FIG. 10 shows a third bridge located corresponding to the fourth piercing hole of FIG. 9.

Referring to FIGS. 9 and 10, the fourth piercing hole 140 may be disposed on an extension line in the direction in which the third piercing holes 130 are arranged. A third upper bridge 413 and a third lower bridge 433 (FIG. 8) may be disposed on the fourth piercing hole 140. The third upper bridge 413 may be disposed on an extension line in the direction in which the ends of the extensions 225 are continuously arranged while being disposed on the first upper gasket 210.

Each of the first piercing hole 110, the second piercing hole 120, and the third piercing hole 130 may be smaller in size than the fourth piercing hole 140. Accordingly, the third upper bridge 413 or the third lower bridge 433 (FIG. 8) disposed on the fourth piercing hole 140 may be larger in size than the bridges located on the first piercing hole 110, the second piercing hole 120, and the third piercing hole 130.

According to an embodiment of the present disclosure, by adjusting the size of the bridge disposed on the piercing hole in proportion to the size of the piercing hole, the surface pressure imbalance may be eliminated and the height imbalance of the gaskets after the injection molding process may be eliminated.

FIG. 11 shows a difference between the upper gasket and the lower gasket on the cathode separator according to an embodiment of the present disclosure. For the sake of brevity, a redundant description is omitted.

Referring to FIGS. 4 and 11, an upper bridge 410 may be provided on the upper gasket 200 provided on the reaction surface of the cathode separator 100, and a lower bridge 430 may be provided on the lower gasket 300 provided on the cooling surface of the cathode separator 100. When the cathode separator 100 is stacked, the upper gasket 200 comes into contact with a sub-gasket 500, and the lower gasket 300 comes into contact with the cooling surface of an anode separator 400. As such, since rigidity of the anode separator 400 in contact with the lower gasket 300 is greater than rigidity of the sub-gasket 500, the surface pressure between the lower gasket 300 and the anode separator 400 may be formed high under the same conditions. Therefore, by providing the size of the upper bridge 410 disposed on the upper gasket 200 to be larger than the size of the lower bridge 430 disposed on the lower gasket 300, the surface pressure between the upper gasket 200 and the sub-gasket 500 may be compensated.

The fact that the upper bridge 410 is larger in size than the lower bridge 430 may mean that the thickness d of the upper bridge 410 is greater than that of the lower bridge 430 based on the direction in which the gaskets 200, 300 extend. Also, the fact that the upper bridge 410 is larger in size than the lower bridge 430 may mean that the first height h1, which is the height of the top of the upper bridge 410 based on the reaction surface of the cathode separator 100, is greater than the second height h2, which is the height of the top of the lower bridge 430 based on the cooling surface of the cathode separator 100.

As is apparent from the foregoing, according to an embodiment of the present disclosure, although there occurs a height difference of gaskets due to a shrinkage difference between a piercing hole and the other portion of a cathode separator after gasket injection molding, the shrinkage difference at a position where the piercing hole is provided can be prevented by a bridge disposed at a position corresponding to the piercing hole.

According to an embodiment of the present disclosure, the surface pressure between the piercing hole and the gasket can be reinforced by locating the bridge on the piercing hole.

According to an embodiment of the present disclosure, since the bridge is disposed on the gasket having a double uneven structure, sealing performance can be improved by the gasket.

According to an embodiment of the present disclosure, by providing a relatively large bridge in a portion where surface pressure is weak during an injection molding process, the surface pressure imbalance between the gasket and the cathode separator can be eliminated.

Although embodiments of the present disclosure have been described with reference to the accompanying drawings, those skilled in the art will appreciate that the present disclosure may be embodied in other specific forms without changing the technical spirit or essential features thereof. Therefore, the embodiments described above should be understood to be non-limiting and illustrative in every way.

What is claimed is:

1. A gasket for reinforcing surface pressure, disposed on a separator comprising at least one piercing hole provided along a line where sealing is required, the gasket comprising:
a double uneven structure protruding from the separator; and
a bridge provided at a position corresponding to the at least one piercing hole,
wherein the bridge is disposed in a trough provided by the double uneven structure.

2. The gasket of claim 1, wherein a height of a top of the bridge is less than a height of a top of the double uneven structure based on one surface of the separator.

3. The gasket of claim 1, wherein the gasket comprises an upper gasket disposed on a reaction surface of the separator and a lower gasket disposed on a cooling surface of the separator, and the bridge comprises an upper bridge provided to the upper gasket and a lower bridge provided to the lower gasket based on a position of the piercing hole.

4. The gasket of claim 3, wherein the upper bridge is thicker than the lower bridge based on a direction in which the gasket extends, or a height of a top of the upper bridge based on the reaction surface of the separator is greater than a height of a top of the lower bridge based on the cooling surface of the separator.

5. The gasket of claim 1, wherein the gasket comprises a first gasket disposed between a perimeter of the separator and manifolds through which reaction gases or coolant flow, and a second gasket disposed on a flow path of the reaction gases or coolant discharged from the manifolds or introduced into the manifolds.

6. The gasket of claim 5, wherein the bridge comprises a first bridge provided to the first gasket and a second bridge provided to the second gasket.

7. The gasket of claim 6, wherein, among a plurality of second bridges provided on the second gasket disposed at a position corresponding to any one of the manifolds, the second bridges disposed at both ends are larger in size than the remaining second bridges.

8. The gasket of claim 7, wherein the second gasket comprises a plurality of extensions extending along the flow path of the reaction gases or coolant discharged from the manifolds or introduced into the manifolds, and the second bridges are disposed outside connection points between the second gasket and the two extensions disposed at both ends based on any one of the manifolds.

9. The gasket of claim 6, wherein, among a plurality of second bridges provided on the second gasket disposed at a position corresponding to each of coolant manifolds associated with the coolant among the manifolds, at least one second bridge disposed at a central portion of the second gasket is smaller in size than the remaining second bridges.

10. The gasket of claim 6, wherein the bridge comprises a third bridge provided at a point of the first gasket connected to the second gasket disposed on the cooling surface of the separator, and the third bridge is larger in size than the first bridge.

11. A separator assembly having a gasket for reinforcing surface pressure, comprising:
a separator comprising a plurality of piercing holes provided along a line where sealing is required; and
a gasket comprising a plurality of bridges provided at positions corresponding to the piercing holes,
wherein each of the bridges is disposed on a double uneven structure of the gasket protruding from the separator.

12. The separator assembly of claim 11, wherein each of the bridges is disposed in a trough provided by the double uneven structure.

13. The separator assembly of claim 11, wherein:
the piercing holes comprise a first piercing hole disposed between a perimeter of the separator and manifolds through which reaction gases or coolant flow, and a second piercing hole disposed in a direction toward a central area of the separator from the manifolds, and
the bridges comprise a first bridge provided at a position corresponding to the first piercing hole and a second bridge disposed at a position corresponding to the second piercing hole.

14. The separator assembly of claim 13, wherein, among a plurality of second bridges, the second bridges disposed on the second piercing holes disposed at both ends among a plurality of second piercing holes corresponding to each of the manifolds are larger in size than the remaining second bridges.

15. The separator assembly of claim 13, wherein:
a third piercing hole is provided in a direction toward the central area of the separator from partial manifolds associated to the reaction gases among the manifolds,
the third piercing hole is spaced apart from the partial manifolds compared to the second piercing hole, and
among a plurality of second bridges, the second bridges disposed on the third piercing holes disposed at both ends among a plurality of third piercing holes corresponding to each of the partial manifolds are larger in size than the remaining second bridges.

16. The separator assembly of claim 15, wherein:
a plurality of first piercing holes comprises a fourth piercing hole disposed on an extension line in a direction in which the third piercing holes are arranged,
the plurality of the bridges comprise a third bridge provided at a position corresponding to the fourth piercing hole, and
the third bridge is larger in size than the first bridge.

17. The separator assembly of claim 11, wherein the gasket comprises an upper gasket disposed on a reaction surface of the separator and a lower gasket disposed on a cooling surface of the separator, and an upper bridge disposed on the upper gasket among the bridges is larger in size than a lower bridge disposed on the lower gasket among the bridges.

18. A separator assembly for reinforcing surface pressure at a piercing hole, comprising:
a separator having at least one piercing hole disposed along a sealing region; and
a gasket disposed on the separator, the gasket including at least one bridge aligned with the at least one piercing hole,
wherein the bridge is configured with a thickness or shape selected to compensate for shrinkage differences or to increase sealing force relative to surrounding portions of the gasket.

19. The separator assembly of claim 18,
wherein the gasket is formed by an injection molding process having one or more gate locations, and
wherein the bridge has a dimension larger or smaller than other bridges of the gasket based on proximity to a gate location to offset thickness variations that occur during injection molding.

20. The separator assembly of claim 18,
wherein the gasket comprises a double-uneven structure protruding from the separator, and
wherein each bridge is at least partially disposed within a trough defined by the double- uneven structure.
